(19) United States
(12) Patent Application Publication
(10) Pub. No.: US 2018/0019987 A1
(43) Pub. Date: Jan. 18, 2018

(54) System and method for creating an electronic signature containing a captured signature, date and time, physical location address, and unique identifier.

(71) Applicant: Thien Pham, Lacey, WA (US)

(72) Inventor: Thien Pham, Lacey, WA (US)

(73) Assignees: Synergex Group, Greenwhich, CT (US); Wayne Taylor, Chandler, AZ (US); Pham Holdings, Lacey, WA (US)

(21) Appl. No.: 15/212,265

(22) Filed: Jul. 17, 2016

(51) Int. Cl. H04L 29/06; G01S 19/03

(52) U.S. Cl. CPC H04L 63/08; G01S 19/03

(57) ABSTRACT

System and method for creating an electronic signature containing a captured signature, date and time, physical location address, and unique identifier.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to a computer program that captures a signature, gets the Global Positioning System coordinate of the device, creates a unique identifier, and creates an electronic signature containing the captured signature, the date and time when the captured signature was created, the physical location where the captured signature was created, and the unique identifier of the captured signature.

### BACKGROUND OF THE INVENTION

Electronic signature has been around for quite some time. There are many electronic signature companies out there offering different variations of the electronic signature. The problem with those electronic signature is that the electronic signature cannot be use to prove the identity of the signer.

What is needed is a system and method for creating an electronic signature that contains the captured signature, the date and time the signature was captured, the physical location where the signature was created, and a unique identifier to represent the captured signature for later verification.

### BRIEF SUMMARY OF THE INVENTION

In a typical application, an electronic document is presented to the user with a signature field. The user clicks on the signature field or clicks on a button on the electronic document to activate the signature capture. The user then draws his/her signature using the movement of a computer mouse, finger, or stylus. Once the user completes his/her signature, the application then retrieves the Global Positioning System (“GPS”) coordinate of the device and connects to the GPS Server to translate the GPS coordinate to a physical address. The program then creates a unique identifier for the signature and creates an electronic signature containing the captured signature, the date and time of the captured signature, the physical address and the unique identifier.

### BRIEF DESCRIPTION OF THE SEVERAL VIEWS OF THE DRAWING

FIG. 1 illustrates an exemplary environment where the present invention operates on a device and connects to a GPS Server to retrieve a physical address using a Global Positioning System coordinate.

FIG. 2 illustrates how an electronic signature with captured signature, date and time, physical address, and unique identifier is placed inside an electronic document.

FIG. 3 illustrates the features of the electronic signature image.

FIG. 4 illustrates the process for creating the electronic signature.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

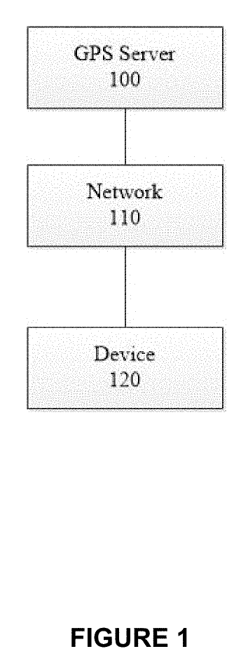

FIG. 1 illustrates an exemplary environment for retrieving a physical address. The present invention is a computer program that runs on device 120. Device 120 is coupled to GPS Server 100 via the network 110. Device 120 has the capability to capture a drawn signature using the movement of a computer mouse, finger, or stylus. GPS server 100 is use to translate a Global Positioning System (“GPS”) coordinate to a physical address and return the physical address to the computer program running on device 120 via the network 110.

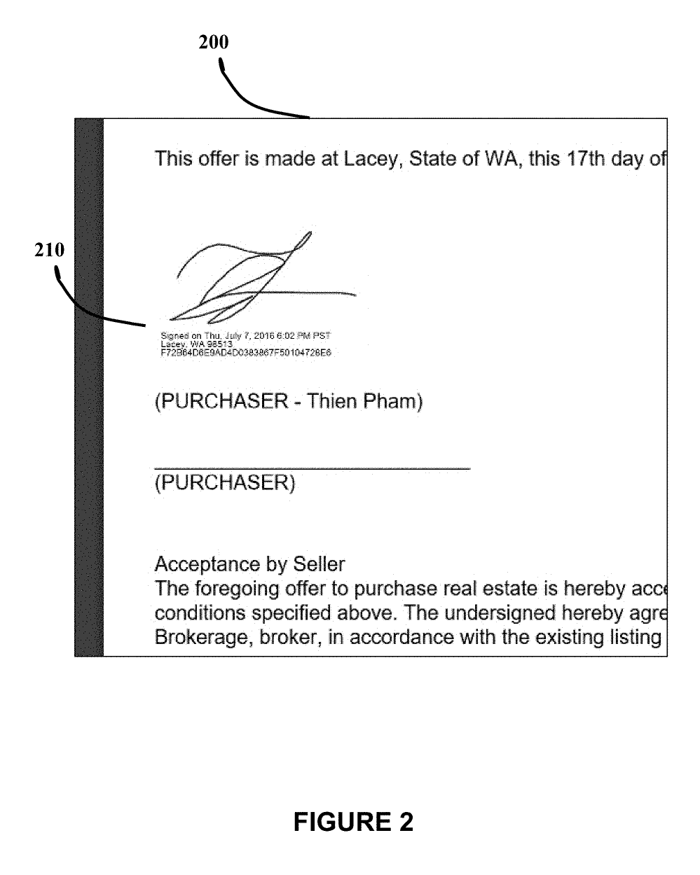

FIG. 2 illustrates how an electronic signature with captured signature, date and time, physical address, and unique identifier is placed inside an electronic document. The electronic signature 210 can be placed anywhere inside the electronic document 200. Electronic document 200 is an example where it can embed an electronic signature 210. Electronic signature 210 is not limited to being use inside electronic documents, images, or the likes.

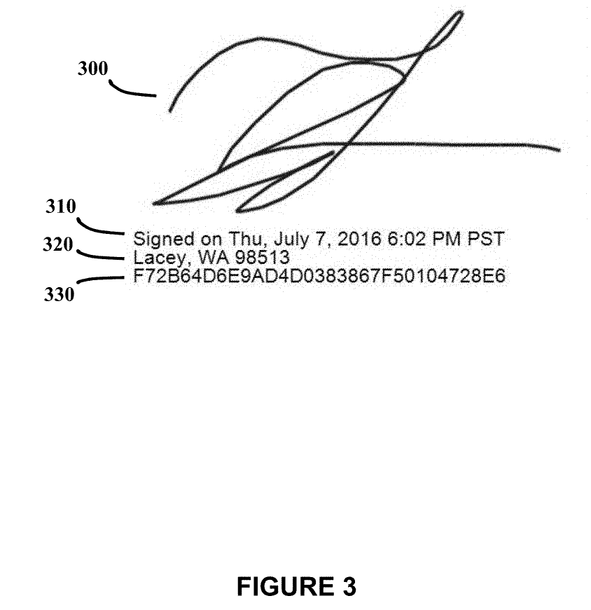

FIG. 3 illustrates the features of the electronic signature. The electronic signature consists of the captured signature 300, the date and time the captured signature was created 310, the physical address 320 returned by the GPS Server 100, and the created unique identifier 330.

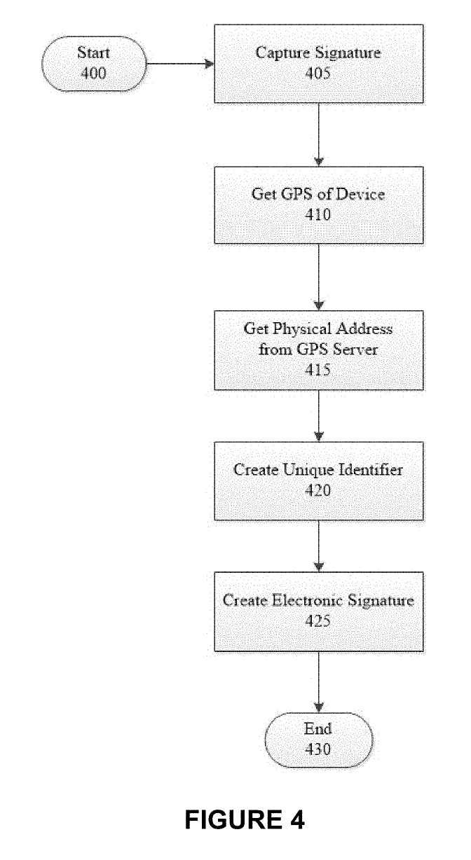

FIG. 4 illustrates the process for creating the electronic signature image. The present invention is a computer program that runs on device 120. Device 120 has the capability of capturing a drawn signature using the movement of a computer mouse, finger, or stylus. The program starts at Step 400 and proceeds to Step 405. At Step 405, the program requests the user to draw his/her signature using the movement of a computer mouse, finger, or stylus. Once user has drawn his/her signature, the program stores it to device memory and proceeds to Step 410. At Step 410, the program retrieves the GPS coordinate of the device being used to capture the signature of the user. The program then continues to Step 415. At Step 415, the program connects to GPS Server 100 via the network 110 and passes the GPS coordinate of the device 120. The GPS Server 100 then returns the physical address representing the GPS coordinate to the program and the program stores it to device memory. The returned physical address may contain all or parts of a physical address. For example, if the GPS Server 100 is unable to translate the GPS coordinate to the exact physical building address, the GPS Server 100 will return the city, state/province, and ZIP/Postal code. The program then continues to Step 420. At Step 420, the program creates a unique identifier to represent the electronic signature 210 and continues to Step 425. At Step 425, the program creates an electronic signature 210, using the captured signature at Step 405, the date and time of the captured signature at Step 405, the physical address returned by GPS Server 100 at Step 415, and the created unique identifier at Step 420. The program then continues to Step 430 where it ends.

Several embodiments are specifically illustrated and/or described herein. However, it will be appreciated that modifications and variations are covered by the above teachings and within the scope of the appended claims without departing from the spirit and intended scope thereof.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A method for creating an electronic signature comprising the steps of:
(a) capturing a signature;
(b) getting a GPS coordinate of the device being used to capture a signature;
(c) connecting a GPS server to retrieve the physical address using the GPS coordinate at Step (b);
(d) creating a unique identifier to represent the electronic signature;
(e) creating an electronic signature using the captured signature at Step (a), the date and time the captured signature was created at Step (a), the physical address returned by the GPS server at Step (c), and the created unique identifier at Step (d).

2. The method of claim 1, wherein the returned physical address may contain all or parts of a physical address.

3. The method of claim 1, wherein the electronic signature consists of the captured signature drawn by the movement of a computer mouse, finger, or stylus, the date and time of the captured signature, the physical address where the captured signature was created, and a unique identifier.
